(19) United States
(12) Patent Application Publication
(10) Pub. No.: US 2012/0228985 A1
(43) Pub. Date: Sep. 13, 2012

(54) SQUIRREL-CAGE ROTOR OF INDUCTION MOTOR AND PRODUCTION METHOD THEREOF WHEREIN END RING IS BRAZED WITH BAR

(75) Inventors: Daisuke HAYAHI, Yamanashi (JP); Masamoto FUKUDA, Yamanashi (JP); Hisashi MAEDA, Yamanashi (JP)

(73) Assignee: FANUC CORPORATION, Yamanashi (JP)

(21) Appl. No.: 13/413,725

(22) Filed: Mar. 7, 2012

(30) Foreign Application Priority Data
Mar. 11, 2011 (JP) 2011-054108

(51) Int. Cl. H02K 17/16; H02K 15/02

(52) U.S. Cl. 310/211; 29/598

(57) ABSTRACT

A squirrel-cage rotor of an induction motor and a production method thereof, wherein locating of the brazing material is not necessary in order to reduce manhours for brazing, and a bar is easily connected to an end ring. Before assembling a rotor core, a silver plated layer is formed on at least one of an end ring and a conductive bar. In order to melt the silver plated layer, the rotor is heated to a temperature which is equal to or larger than the melting point of the silver plated layer. The melted layer functions as a brazing material, whereby the end ring and the conductive bar are connected.

### BACKGROUND OF THE INVENTION

1. Field of the Invention

The present invention relates to a squirrel-cage rotor of an induction motor and a production method thereof, wherein an end ring is brazed with a bar.

2. Description of the Related Art

Generally, a squirrel-cage rotor of an induction motor is constituted by major three components, i.e., a laminated core produced by punching a magnetic steel sheet, slot-shaped conductive bodies positioned in a plurality of slots formed in the core, and an end ring for short-circuiting the conductive bodies at both ends of the rotor. Usually, to reduce cost the slot-shaped conductive bodies and the end ring are integrally formed with the rotor core, by die-cast molding of aluminum.

In recent years, it is desired to reduce heat generated by a motor, and then copper or copper alloy, having lower electric resistance than aluminum, may be used as the metal that forms a conductive portion of a rotor of the motor. The melting point of copper or copper alloy is higher than that of aluminum, and thus it is difficult to utilize a die-cast process or the like for producing the motor, since the rotor core is a magnetic steel sheet that may be affected by the die-cast process. Therefore, when copper or copper alloy is used for the conductive portion of the rotor, a method is well known wherein a conductive body of the slot portion is configured as a bar-shaped member, the end ring for short-circuiting is configured as a thin circular disc through which the slot conductive body extends, and the conductive body is connected to the end ring by brazing or the like. In the case of brazing, the temperature is increased to about 800 degrees by using high-frequency heating or a furnace, in order to melt brazing filler metal and connect the conductive body to the end ring.

As an example of brazing a copper bar and a copper end ring, there is a conventional method wherein brazing filler material is positioned near a gap between the copper bar and the copper end ring, and then heated and melted filler material flows into the gap so as to connect the bar and the end ring. For example, Japanese Unexamined Patent Publications (Kokai) No. 2004-254433 discloses a production method of a squirrel-cage rotor, wherein a bar 1 moved to the side of an inner surface of a through hole 7 of an end ring 2, which is opposed to a rotor core 3, and then a wire-shaped brazing filler material 4 is positioned within a groove 11 so as to hold bar 1, before the temperature does not reach a brazing temperature. After the temperature reaches the brazing temperature, through hole 7 of end ring 2 is moved due to heat expansion of end ring 2 so that bar 1 is positioned at generally the center of through hole 7 of end ring 2, and then vacuum microwave brazing or atmosphere gas microwave brazing is carried out.

Japanese Unexamined Patent Publications (Kokai) No. 8-294256 discloses a production method of a rotor for an induction motor, wherein a recess 5 for containing melted brazing material is formed in an end ring 4 made from oxygen-free copper, a brazing flux 6 is applied to recess 5 and an end of a rotor bar 3, and a brazing material 7, configured by bending a rod-shaped silver brazing material, is inserted into the end of rotor bar 3. Then, end ring 4 is rotated by means of a rotating table 9, rotor bar 3 is closely attached to recess 5 of end ring 4 when the temperature of end ring 4 reaches 800 degrees C. by means of a burner 10, so that the temperature of rotor bar 3 reaches the brazing temperature, and after brazing material 7 is melted, the heating is stopped and the rotor is naturally cooled.

On the other hand, it is a conventional technique to locate a brazing material at a connection point between components, and then melt the brazing material by using a gas burner to connect the components. For example, Japanese Unexamined Patent Publications (Kokai) No. 4-222446 discloses a squirrel-cage electric motor, wherein a short-circuiting ring 3 is raised so that a lower surface of a rotating bar 2 is attached to a groove 3a of short-circuiting ring 3, short-circuiting ring 3 and rotating bar 2 are heated by approaching a gas burner 5 or a microwave coil 6 from below, and short-circuiting ring 3 and rotating bar 2 are brazed by supplying a silver brazing rod or film in groove 3a.

In the method of Japanese Unexamined Patent Publications (Kokai) No. 2004-254433 or Japanese Unexamined Patent Publications (Kokai) No. 8-294256, manhours before brazing, such as processing or locating the brazing material, may be increased. On the other hand, in the method of Japanese Unexamined Patent Publications (Kokai) No. 4-222446, it is necessary to continuously supply the brazing material during brazing, which results in increased manhours.

### SUMMARY OF THE INVENTION

Therefore, an object of the present invention is to provide a squirrel-cage rotor of an induction motor and a production method thereof, wherein locating of the brazing material is not necessary in order to reduce manhours for brazing, and a bar is easily connected to an end ring.

One aspect of the present invention provides a squirrel-cage rotor of an induction motor having a rotor bar and an end ring which are connected by brazing, wherein a plated layer is formed on a connecting surface of at least one of the end ring and the rotor bar, and the plated layer functions as a brazing material for the brazing so that the end ring and the rotor bar are connected.

In a preferred embodiment, the end ring has a single-plate structure.

In a preferred embodiment, the plated layer is formed on an entire surface of the end ring.

In a preferred embodiment, the end ring and the rotor bar are made from copper or copper alloy, and the plated layer is a silver plated layer.

Another aspect of the present invention provides a production method of a squirrel-cage rotor of an induction motor, comprising the steps of: forming a plated layer on at least one of an end ring and a rotor bar so that the plated layer is formed on at least a connecting surface between the end ring and the rotor bar; locating the end ring and the rotor bar at predetermined assembling positions; and heating and melting the plated layer so that the end ring and the rotor bar are connected by using the melted plated layer as a brazing material.

In a preferred embodiment, the step of forming the plated layer comprising forming the plated layer on an entire surface of the end ring.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 shows a schematic configuration of a squirrel-cage rotor according to one embodiment of the invention;

FIG. 2 is an enlarged view of around an end ring when each component of the rotor is assembled; and

FIG. 3 is an enlarged view of around the end ring after the rotor is heated above the brazing temperature.

### DETAILED DESCRIPTION

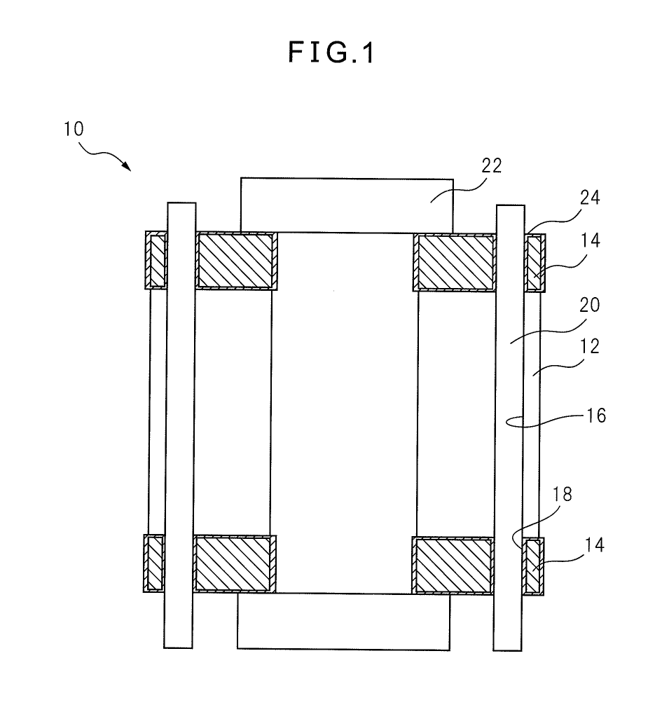

FIG. 1 shows a schematic configuration of a squirrel-cage rotor 10 according to one embodiment of the invention, wherein a sectional view along a rotation axis of the rotor is illustrated. Squirrel-cage rotor 10 has a rotor core 12 made from a silicon steel sheet or plate, and an end ring 14 made from pure copper or copper alloy and positioned at both ends of rotor core 12 in relation to a rotation axis of the rotor core. Rotor 10 further has at least one conductive rotor bar 20 made from pure copper or copper alloy and configured to be inserted into a though hole 16 formed in rotor core 12 and a through slot 18 formed in end ring 14, and a fixture 22 configured to fix the above components or the rotor.

The shape of through slot 18 of end ring 14 is generally complementary to the outer shape of conductive bar 20. In the illustrated embodiment, each of an inner surface of through slot 18 and an outer surface of conductive bar 20 is a cylindrical surface. However, through slot 18 and conductive bar 20 may have other shapes as long as they are generally complementary to each other. Although through slot 18 may be formed as a notch or a cutout at the radially peripheral portion of the end ring, it is preferable that the radial section of through slot 18 is fully surrounded by material which forms end ring 14, in view of brazing strength.

In the present invention, before rotor 10 is assembled as shown in FIG. 1, a plated layer (preferably, a silver plated layer) 24 is formed on at least one of end ring 14 and conductive bar 20. It is necessary that silver plated layer 24 be formed on at least one of end ring 14 and conductive bar 20 so that plated layer 24 is formed on at least a connecting site or surface between end ring 14 and conductive bar 20. In the embodiment of FIG. 1, silver plated layer 24 is formed on an entire surface of end ring 14. By virtue of this, a silver plating is easier than forming a silver plated layer on only the connecting site, and an advantage may be obtained as below.

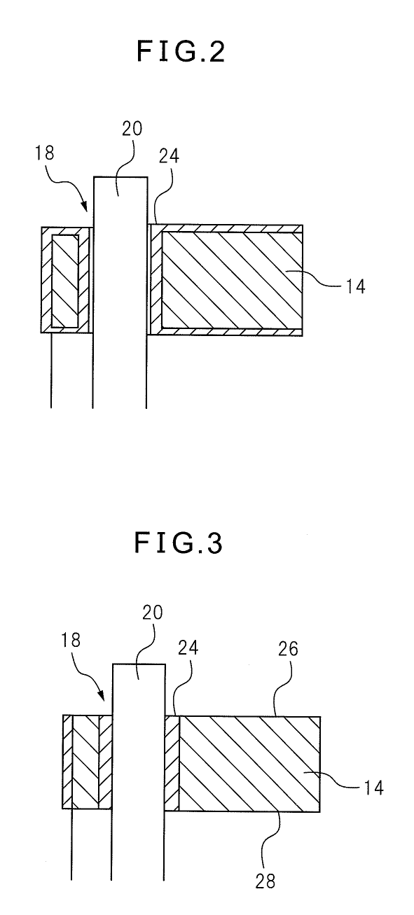

With reference to FIGS. 2 and 3, a production method of rotor 10 is explained. First, as described above, silver plated layer 24 is previously formed on (in this case, the entire surface of) end ring 14, and each component of rotor 10 is assembled and positioned at predetermined assembling position. In this regard, as shown in FIG. 2 which is an enlarged view of the connecting site between end ring 14 and conductive bar 20, there may be a gap between through slot 18 of end ring 14 and conductive bar 20. In other words, each conductive bar 20 may not be precisely aligned with the center of each slot 18 of end ring 14.

Next, rotor 10 is heated to the temperature (for example, 800 degrees C.) which is equal to or larger than the melting point of silver plated layer 24, by means of high-frequency heating or by locating the rotor in a furnace. Due to this, the melted plated layer functions as brazing material, and end ring 14 and conductive bar 20 are connected to (or brazed with) each other. In the invention, by previously forming silver plated layer 24, it is not necessary to locate or supply brazing material during brazing, nevertheless the bonding strength, which is equivalent to that of conventional brazing using brazing material, may be obtained.

In the illustrated embodiment, the entire rotor is heated. However, only the connecting site between end ring 14 and conductive bar 20 or near may be heated. By forming silver plated layer 24 on the entire surface of end ring 14, as in the embodiment, and heating the entirety of rotor 10 or the entirety of end ring 14, most of the silver plated layer, formed on a portion (for example, upper surface 26 and lower surface 28 of end ring 14) which is other than the connecting site between end ring 14 and conductive bar 20, flows into slot 18 due to capillary action or the like, as shown in FIG. 3 which shows the state wherein silver plated layer 24 is melted (i.e., the temperature of the rotor has reached the brazing temperature). Therefore, the melted plated layer fills the gap between through slot 18 and conductive bar 20, whereby high bonding strength may be obtained.

In order to facilitate the above flow action of the melted plated layer into slot 18, the upper and/or lower surface of end ring 14 may have a slope descending toward slot 18 or a groove fluidly communicated with slot 18.

In addition, end ring 14 may be constituted by laminating a plurality of thin sheet or plate made from copper or copper alloy. However, it is advantageous that end ring 14 be constituted as a single-plate structure by machining a single sheet or plate made from copper or copper alloy, in view of cost and the number of production processes.

According to the present invention, locating the brazing material is not necessary during the brazing, since the plated layer is used as the brazing material. Further, previously processing the brazing material in a predetermined shape, and manually and continuously supplying the brazing material during the brazing, are not necessary.

By constituting the end ring as a single-plate structure, the production process of the end ring is simplified, whereby the production cost of the rotor may be reduced.

By forming the plated layer on the entire surface of the end ring, the melted layer flows between the bonding surfaces of the end ring and the conductive bar during brazing, whereby the end ring and the conductive bar may be integrally connected.

While the invention has been described with reference to specific embodiments chosen for the purpose of illustration, it should be apparent that numerous modifications could be made thereto, by one skilled in the art, without departing from the basic concept and scope of the invention.

1. A squirrel-cage rotor of an induction motor having a rotor bar and an end ring which are connected by brazing,
wherein a plated layer is formed on a connecting surface of at least one of the end ring and the rotor bar, and the plated layer functions as a brazing material for the brazing so that the end ring and the rotor bar are connected.

2. The squirrel-cage rotor of the induction motor as set forth in claim 1, wherein the end ring has a single-plate structure.

3. The squirrel-cage rotor of the induction motor as set forth in claim 1, wherein the plated layer is formed on an entire surface of the end ring.

4. The squirrel-cage rotor of the induction motor as set forth in claim 1, wherein the end ring and the rotor bar are made from copper or copper alloy, and the plated layer is a silver plated layer.

5. A production method of a squirrel-cage rotor of an induction motor, comprising the steps of:
forming a plated layer on at least one of an end ring and a rotor bar so that the plated layer is formed on at least a connecting surface between the end ring and the rotor bar;
locating the end ring and the rotor bar at predetermined assembling positions; and
heating and melting the plated layer so that the end ring and the rotor bar are connected by using the melted plated layer as a brazing material.

6. The production method as set forth in claim 5, wherein the step of forming the plated layer comprising forming the plated layer on an entire surface of the end ring.
